(19) United States
(12) Patent Application Publication
(10) Pub. No.: US 2020/0157881 A1
(43) Pub. Date: May 21, 2020

(54) Windowpane Covers

(71) Applicant: Nathaniel Bouknight, Henderson, NV (US)

(72) Inventor: Nathaniel Bouknight, Henderson, NV (US)

(21) Appl. No.: 16/195,691

(22) Filed: Nov. 19, 2018

(51) Int. Cl. E06B 9/386; B44C 1/165

(52) U.S. Cl. CPC E06B 9/386; B44C 1/165

(57) ABSTRACT

WINDOWPANE COVERS CAN BE AN ALTERNATIVE TO HAVING CUSTOM SHADES OR BLINDS MADE FOR EVERY WINDOW WITHIN THE HOME. THEY ARE FRAMELESS REVERSE PRINT PANELS, IMAGES ARE PRINTED ON THE BACK AND VIEWED FROM THE FRONT. THEY'RE TRANSPARENT, IMAGES ILLUMINATE DURING DAYLIGHT AND ARE CLEARLY SEEN. NO SCREWS OR BOLTS NEEDED FOR INSTALLATION, THEY EASILY FIT WITHIN THE FRAME AGAINST THE WINDOWPANE ACCORDING TO ITS DIMENSIONS. ADDITIONALLY, SOLID COLOR WINDOWPANE COVERS CAN BE USED TO BLOCK THE SUN.

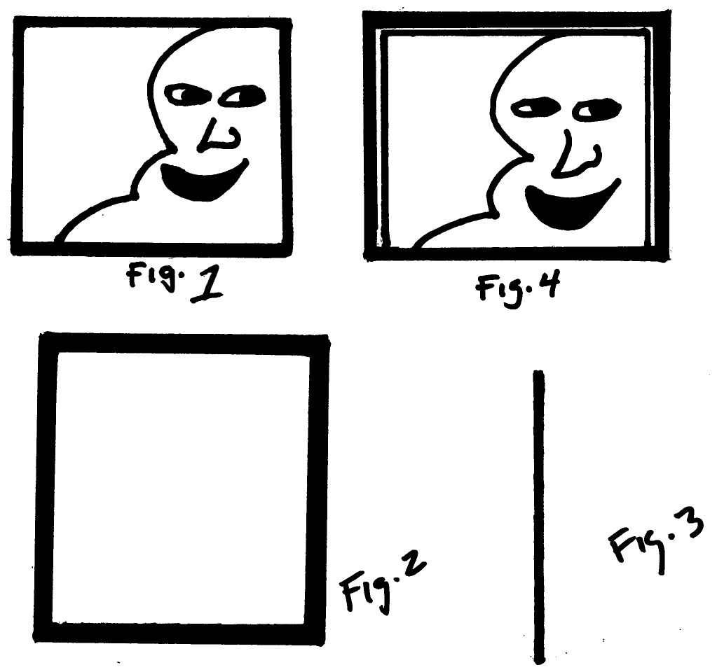

### FIELD OF THE INVENTION

The invention relates to window treatments, US Patent Class D06. To be more specific window coverings for residential homes.

### SUMMARY OF THE INVENTION

Artistic images printed on glass, acrylic, and or hard plastic is not new. However, Windowpane Covers artistic panels are distinguished by its use and purpose. Made specifically for indoor use as a decorative product to cover residential picture windows. They provide privacy, limits sunlight, images illuminate from the interior side during daylight.

### DESCRIPTION OF THE INVENTION

Windowpane Covers are crystal clear acrylic panels, cut straight according to the dimensions of an existing window pane, ideal thickness is either an ⅛″ or ¼″.

Using reverse print technology—artwork is printed on the back of the panel and viewed from the front, artwork is backed with white ink making the view of the art solid from the front, primarily for decorative purposes.

Windowpane Covers are hand placed from the interior side therefore no screws, bolts, tools, braces, adhesives, and or brackets are needed to place the panel within the window frame against the window pane.

1.-2. (canceled)

3. Windowpane Covers are acrylic panels with art printed on the back and viewed from the front. Refer to claim #4.

4. Windowpane Covers are decorative and for indoor use. Refer to claim #5.

5. Windowpane Covers are hand placed within the frame of an existing window, against the window pane.

6. No screws, bolts, tools, braces, adhesives, and or brackets needed to install Windowpane Covers.

7. Windowpane Covers provide privacy, limits incoming sunlight, artwork illuminates from the front during daylight.
